(19) United States
(12) Patent Application Publication
(10) Pub. No.: US 2009/0064505 A1
(43) Pub. Date: Mar. 12, 2009

(54) Vegetable Cutter

(76) Inventor: Hakim M. Afzalzada, Landcaster, TX (US)

Correspondence Address: HARSHAW RESEARCH, INC., 210 W. TECUMSEH STREET, OTTAWA, KS, 66067, US

(21) Appl. No.: 11/854,221

(22) Filed: Sep. 12, 2007

(51) Int. Cl. B26B 3/00

(52) U.S. Cl. 30/299

(57) ABSTRACT

A vegetable cutter includes an extrusion blade for cutting a vegetable such as a potato. The cutter includes a press plate that is linearly movable relative to the extrusion blade between a first configuration spaced apart from the extrusion blade and a second configuration adjacent the extrusion blade. A lead screw is operatively coupled to a motor and to the press plate to move the press plate between first and second configurations. A cutting blade is positioned adjacent the extrusion blade and a drive screw is operatively coupled to the cutting blade and to either the lead screw or motor so as to rotate the cutting blade. A vegetable positioned between the press plate and extrusion blade is forced through the extrusion blade when the press plate is moved to the second configuration. The extrusion blade is configured as an alphanumeric character for likewise shaping the vegetable.

### BACKGROUND OF THE INVENTION

The present invention relates generally to vegetable cutting equipment and, more particularly, to a vegetable cutter that cuts potatoes to form french fries in the form of alphanumeric or other symbols.

French fries are a common fast food product in the United States and around the world. Typically, potatoes are cut to form french fries having a relatively long and straight configuration although curly fries or other configurations are possible.

Various devices have been proposed in the art for cutting vegetables and even for cutting french fries. Although presumably effective for their intended purposes, the existing devices do not provide interchangeable dies for selectively cutting potatoes into alphanumeric characters. Further, the existing devices do not provide a machine that maximizes the quantity of letters cut from each potato. In addition, the existing devices do not operate both an extrusion blade (through which a potato is forced) and a cutting blade (that cuts the extruded potato from the mold) at corresponding speeds to maintain a uniform thickness at any speed.

Therefore, it would be desirable to have a vegetable cutter that cuts potatoes to form french fries in a manner that overcomes the disadvantages recited above. More particularly, it would be desirable to have a vegetable cutter that cuts french fries into alphanumeric characters in a manner that minimizes potato waste and which maximizes the amount of each potato that may be formed into the desired shapes.

### SUMMARY OF THE INVENTION

Accordingly, a vegetable cutter according to the present invention includes an extrusion blade for cutting a vegetable such as a potato. The vegetable cutter includes a press plate that is linearly movable relative to the extrusion blade between a first configuration spaced apart from the extrusion blade and a second configuration immediately adjacent the extrusion blade. A lead screw is operatively coupled to a motor and to the press plate to selectively move the press plate between the first and second configurations. A cutting blade is positioned adjacent the extrusion blade and a drive screw is operatively coupled to the cutting blade and to either the lead screw or motor so as to rotate the cutting blade.

In function, the press plate is moved downwardly toward the extrusion blade and causes a potato or other vegetable that is positioned between the push plate and extrusion blade to be forced therethrough. As the extrusion blade is in the form of an alphanumeric symbol, the potato is cut by the extrusion blade into pieces shaped according to the blade's symbol. As the cutting blade and the press plate are both coupled to the lead screw, the speed of forcing a vegetable through the extrusion blade and then being cut by the cutting blade always occurs at the same proportionate speed and, therefore, maintains a predetermined thickness

Therefore, a general object of this invention is to provide a vegetable cutter that cuts vegetables such as potatoes to form french fries in the form of alphanumeric or other ornamental characters.

Another object of this invention is to provide a vegetable cutter, as aforesaid, that cuts french fries from potatoes in a manner that maximizes usage of the potato and, consequently, minimizes waste.

Still another object of this invention is to provide a vegetable cutter, as aforesaid, in which extrusion blades are interchangeable for selectively cutting potatoes having different alphanumeric configurations.

A further object of this invention is to provide a vegetable cutter, as aforesaid, in which the extrusion blade and a cutting blade are operatively connected to the same lead screw for proportionately extruding and cutting each piece to a predetermined dimension.

A still further object of this invention is to provide a vegetable cutter, as aforesaid, that is cost effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a vegetable cutter according to the preferred embodiment of the present invention;

FIG. 2a is a top view of the vegetable cutter as in FIG. 1;

FIG. 2b is a sectional view taken along line 2b-2b as in FIG. 2a illustrating the push plate in a first configuration;

FIG. 2c is another sectional view as in FIG. 2b illustrating the push plate in a second configuration;

FIG. 3 is an elevated perspective view of the vegetable cutter as in FIG. 1 with the hopper removed;

FIG. 4a is an isolated perspective view of an extrusion blade of the vegetable cutter;

FIG. 4b is a top view of the extrusion blade as in FIG. 4a; and

FIG. 5 is a bottom perspective view of the vegetable cutter as in FIG. 3.

### DESCRIPTION OF THE PREFERRED EMBODIMENT

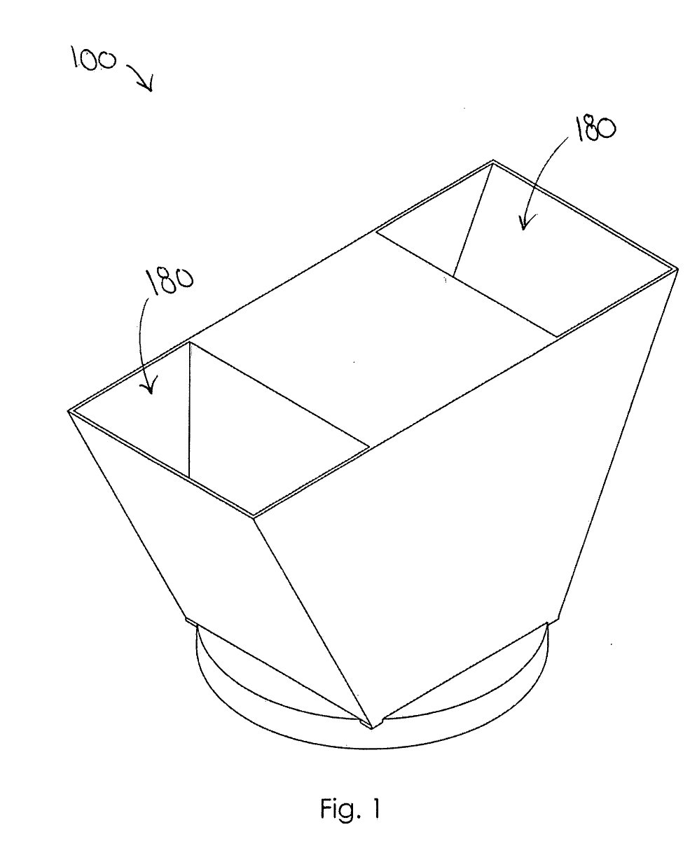

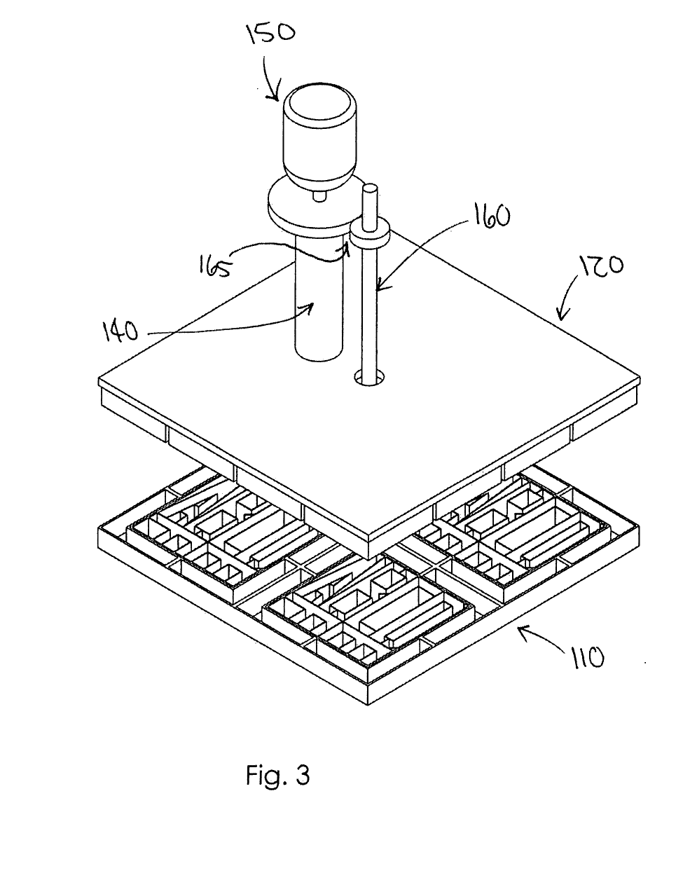

A vegetable cutter 100 according to the present invention will now be described in detail with reference to FIGS. 1 through 5 of the accompanying drawings. More particularly, according to the current invention, a vegetable cutter 100 includes an extrusion blade 110, a press plate 120, and a cutting blade 130.

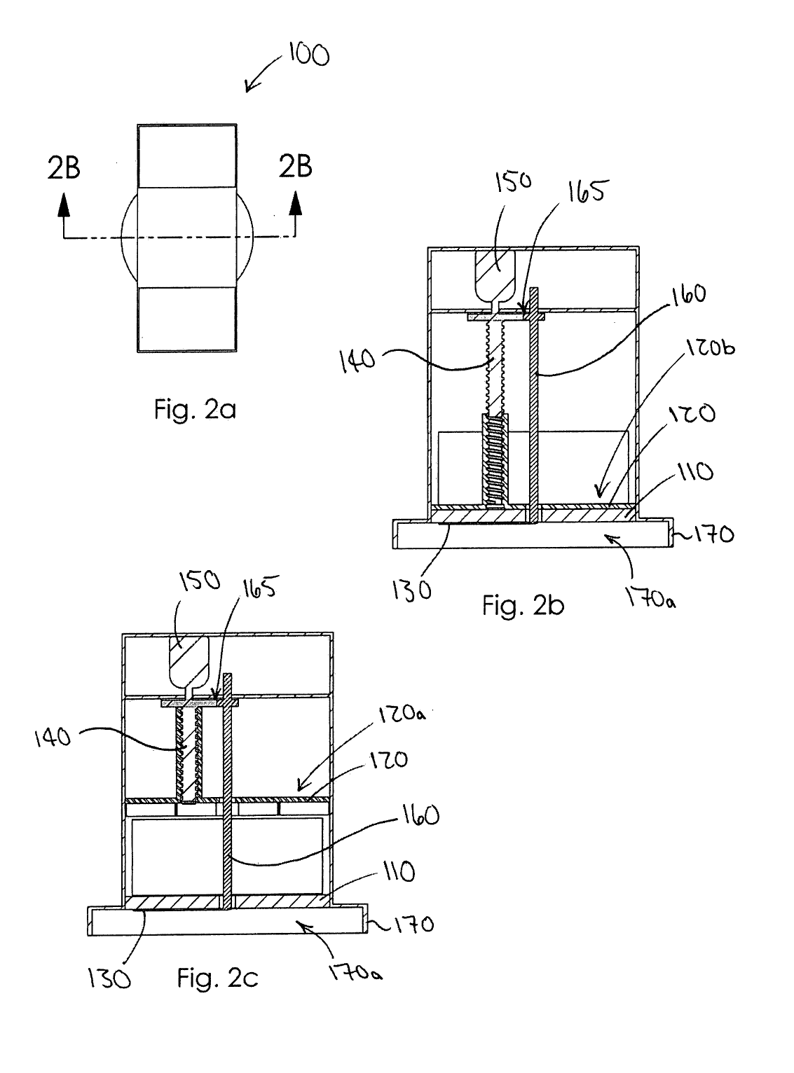

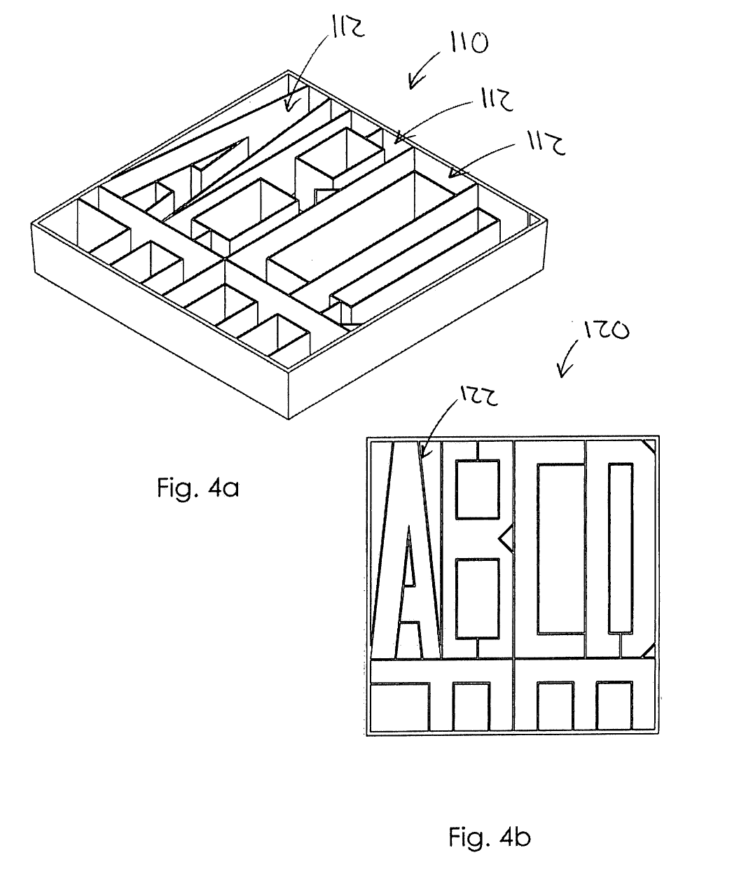

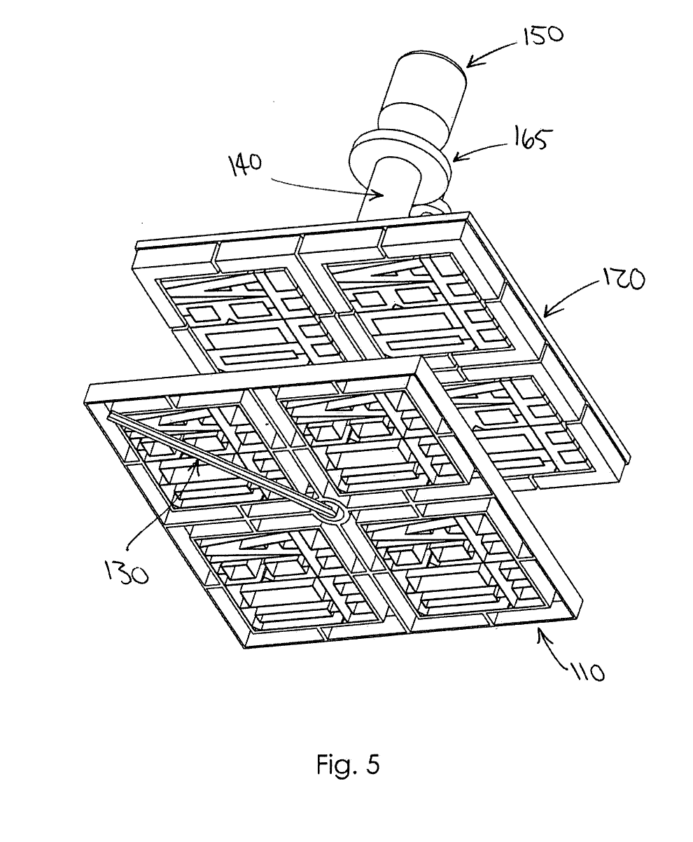

As shown in FIG. 4a, the extrusion blade 110 may define at least one symbol 112 (e.g., an alphanumeric symbol or other representative character) and may be constructed of stainless steel or any other appropriate material. The press plate 120 is linearly movable relative to the extrusion blade 110 for urging a vegetable (e.g., potato, etc.) through the extrusion blade 110. More particularly, the press plate 120 is movable between a first configuration 120a (FIG. 2c) spaced apart from the extrusion blade 110 and a second configuration 120b (FIG. 2b) immediately adjacent the extrusion blade 110. As shown in FIGS. 4b and 5, the press plate 120 may have a configuration 122 that is complementary to a configuration of the extrusion blade 110 (i.e., the at least one symbol 112) to receive a portion of the extrusion blade 110. In other words, the press plate 120 may have a configuration that allows the extrusion blade 110 and the press plate 120 to overlap, ensuring that all of the vegetable is cut by the extrusion blade 110. A lead screw 140 may be operatively coupled to a motor 150 and the press plate 120 to selectively move the press plate 120 between the first and second configurations 120a, 120b (FIGS. 2b and 2c).

The cutting blade 130 may be adjacent the extrusion blade 110 for cutting the vegetable to a predetermined thickness, and as shown in FIG. 5, the extrusion blade 110 may be between the cutting blade 130 and the press plate 120. Means may be included for rotating the cutting blade 130 at a predetermined rate in relation to the movement of the press plate 120 to cut the vegetable to the predetermined thickness. More particularly, to rotate the cutting blade 130, a drive screw 160 may be operatively coupled to the cutting blade 130 and either the lead screw 140 or the motor 150. A connecting apparatus 165 (e.g., gears, pulleys, etc.) may operatively couple the drive screw 160 to the lead screw 140 or the motor 150 so that the cutting blade 130 is rotated at a predetermined rate in relation to the movement of the press plate 120 to cut the vegetable to the predetermined thickness. The connecting apparatus 165 can be configured to provide the predetermined thickness, such as through gear ratios or pulley sizes.

As shown in FIGS. 2b and 2c, a spacer 170 (e.g., a portion of a housing for the extrusion blade 110 and the press plate 120) may define an area 170a beneath the cutting blade 130 and above a ground surface (e.g., a countertop, cutting board, tray, etc.) for temporarily housing the vegetable after the vegetable is cut by the extrusion blade 110 and the cutting blade 130.

A hopper 180, as shown in FIG. 1, may be configured to arrange the vegetable between the extrusion blade 110 and the press plate 120 when the press plate 120 is at the first configuration 120a. In other words, the hopper 180 may act as a conduit to place the vegetable between the extrusion blade 110 and the press plate 120.

In use, the press plate 120 is initially at the first configuration 120a (FIG. 2c). A vegetable (e.g., a potato) may be placed between the press plate 120 and the extrusion blade 110, such as by feeding the vegetable through the hopper 180. The motor 150 may then be actuated, which rotates the lead screw 140, causing the press plate 120 to move to the second configuration 120b. As the press plate moves to the second configuration 120b, the vegetable may be forced through the extrusion blade 110, defining pieces of the vegetable that have the symbol(s) 112 of the extrusion blade 110. Further, as the vegetable moves through the extrusion blade 110, the rotation of the drive screw 160 (tied to the rotation of the motor 150 or the lead screw 140 by the connecting apparatus 165) may rotate the cutting blade 130, cutting the pieces of the vegetable to the predefined thickness. The pieces of the vegetable cut to the predefined thickness may be temporarily held in the area 170a beneath the cutting blade 130. The motor 150 may rotate the lead screw 140 to return the press plate to the first configuration 120a.

It is understood that while certain forms of this invention have been illustrated and described, it is not limited thereto except insofar as such limitations are included in the following claims and allowable functional equivalents thereof.

1. A vegetable cutter, comprising:
an extrusion blade;
a press plate linearly movable relative to said extrusion blade between a first configuration spaced apart from said extrusion blade and a second configuration immediately adjacent said extrusion blade;
a motor;
a lead screw operatively coupled to said motor and said press plate to selectively move said press plate between said first and second configurations;
a cutting blade adjacent said extrusion blade; and
a drive screw operatively coupled to said cutting blade and one of said lead screw and said motor to rotate said cutting blade.

2. The cutter as in claim 1, wherein at least one of gears and pulleys couple said drive screw to said one of said lead screw and said motor.

3. The cutter as in claim 2, wherein said press plate has a configuration complementary to a configuration of said extrusion blade to receive a portion of said extrusion blade.

4. The cutter as in claim 3, further comprising a hopper configured to arrange said vegetable between said extrusion blade and said press plate when said press plate is at said first configuration.

5. The cutter as in claim 4, wherein:
said extrusion blade is between said cutting blade and said press plate; and
said symbol is an alphanumeric symbol.

6. The cutter as in claim 5, further comprising a spacer defining an area beneath said cutting blade for temporarily housing said vegetable after said vegetable is cut.

7. The cutter as in claim 1, further comprising a spacer defining an area beneath said cutting blade for temporarily housing said vegetable after said vegetable is cut.

8. The cutter as in claim 7, wherein at least one of gears and pulleys couple said drive screw to said one of said lead screw and said motor.

9. A vegetable cutter, comprising:
an extrusion blade defining at least one symbol;
a press plate for urging a vegetable through said extrusion blade;
a motor;
a lead screw operatively coupled to said motor and said press plate to selectively move said press plate between a first configuration spaced apart from said extrusion blade and a second configuration immediately adjacent said extrusion blade;
a cutting blade adjacent said extrusion blade for cutting said vegetable to a predetermined thickness;
a drive screw operatively coupled to said cutting blade;
a connecting apparatus operatively coupling said drive screw to one of said lead screw and said motor to rotate said cutting blade at a predetermined rate in relation to said movement of said press plate to cut said vegetable to said predetermined thickness.

10. The cutter as in claim 9, wherein said symbol is an alphanumeric symbol.

11. The cutter as in claim 9, wherein said press plate has a configuration complementary to a configuration of said extrusion blade to receive a portion of said extrusion blade.

12. The cutter as in claim 9, wherein said connecting apparatus includes at least one of gears and pulleys.

13. The cutter as in claim 9, further comprising a hopper configured to arrange said vegetable between said extrusion blade and said press plate when said press plate is at said first configuration.

14. The cutter as in claim 13, wherein:
said extrusion blade is between said cutting blade and said press plate;
said press plate has a configuration complementary to a configuration of said extrusion blade to receive a portion of said extrusion blade;
said connecting apparatus includes at least one of gears and pulleys; and
said cutting blade is spaced apart from a ground surface to define an area for temporarily housing said vegetable after said vegetable is cut.

15. A vegetable cutter, comprising:
an extrusion blade defining at least one symbol;
a press plate for urging a vegetable through said extrusion blade;
a motor;
a lead screw operatively coupled to said motor and said press plate to selectively move said press plate between a first configuration spaced apart from said extrusion blade and a second configuration immediately adjacent said extrusion blade;
a cutting blade adjacent said extrusion blade for cutting said vegetable to a predetermined thickness; and
means for rotating said cutting blade at a predetermined rate in relation to said movement of said press plate to cut said vegetable to said predetermined thickness.

16. The cutter as in claim 15, further comprising a spacer defining an area beneath said cutting blade for temporarily housing said vegetable after said vegetable is cut.

17. The cutter as in claim 16, further comprising a hopper configured to arrange said vegetable between said extrusion blade and said press plate when said press plate is at said first configuration.

18. The cutter as in claim 17, wherein:
said extrusion blade is between said cutting blade and said press plate;
said press plate has a configuration complementary to a configuration of said extrusion blade to receive a portion of said extrusion blade; and
said symbol is an alphanumeric symbol.

19. The cutter as in claim 15, wherein:
said extrusion blade is between said cutting blade and said press plate; and
said press plate has a configuration complementary to a configuration of said extrusion blade to receive a portion of said extrusion blade.

20. The cutter as in claim 19, further comprising a hopper configured to arrange said vegetable between said extrusion blade and said press plate when said press plate is at said first configuration.
